(19) United States
(12) Patent Application Publication
(10) Pub. No.: US 2022/0275684 A1
(43) Pub. Date: Sep. 1, 2022

(54) LADDER ATTACHED PULLEY HOIST AND TOOL RETAINER SYSTEM

(71) Applicant: Jhonatan Tarifa, Gaithersburg, MD (US)

(72) Inventor: Jhonatan Tarifa, Gaithersburg, MD (US)

(21) Appl. No.: 17/731,108

(22) Filed: Apr. 27, 2022

Related U.S. Application Data
(63) Continuation-in-part of application No. 16/746,870, filed on Jan. 18, 2020.

(51) Int. Cl. E06C 7/14; E06C 7/12

(52) U.S. Cl. CPC E06C 7/143; E06C 7/12

(57) ABSTRACT

A ladder pulley hoist and tool retainer system includes a shaft end configured to be received into an opening defined by a hollow rung in a side of an extension ladder and a second end configured with at least one pulley sheave, a length of the shaft being less than or greater than a width of the rungs of the ladder. The system also includes a pulley cord of a length configured to run once around the at least one pulley sheave and bear a load between a pull portion and a load portion. A tool retainer bucket and rack attaches to the shaft. A holder insert is received between the opening defined by a hollow rung in a side of an extension ladder and the shaft, the holder adapted to receive a shaft from both a left side and a right side of the ladder.

### CROSS REFERNCES

This application is a Continuation in Part of application Ser. No. 16/746,870 filed Jan. 18, 2020 for Jhonatan Tarifa and entitled Ladder Attached Pulley Hoist and Tool Retainer

System and is therefore entitled to the priority date of the same.

### BACKGROUND OF THE INVENTION

### Field of Invention

The present invention relates to hollow rung extension ladders, ropes and pulleys.

### Description of Related Art

The Fixed pulley is used for changing the direction of the input force. Fixed pulleys are used for flagpoles or with a hoisting device and is therefore is usually attached to a stationary object above the load. When the rope is pulled downward, the effect is that the load is lifted upwards. This type of pulley will not reduce the effort needed to lift the load, but applies the force of gravity and your weight in your favor. The mechanical advantage is 1 to I. Therefore, to lift the load a foot, one needs to pull a foot of rope downward.

The movable pulley is used to reduce the amount of input force to lift a load. The most popular system that uses this pulley would be a well. Unlike the fixed pulley, the movable pulley is attached to the load and is lifted by pulling up on the rope, making it twice as easier to lift a heavy object. In this case, a 20 pound load could be lifted with just 10 pounds of input force. The tradeoff is that one has to pull twice the amount of rope, and gravity is not in one's favor by pulling off.

The block and tackle uses one fixed and one movable pulley to reduce the amount of force needed to lift an object. However, many pulleys are incorporated into the block and tackle system. The trade off is that one has to pull however many times more rope to lift the object. The mechanical advantage decides how much rope would be needed to pull the object a certain distance and how much force is needed to move the object.

### SUMMARY OF THE DISCLOSURE

A hollow rung ladder apparatus includes a first tubular insert and a second tabular insert each having a first end received into a hollow rung of the hollow rung ladder and a second end configured to receive a respective end of a two end pulley. The disclosure also includes a pivot configured to attach to a rope of the pulley and to travel on the rope at a fixed point on the rope and at fixed angle to the rope and from a first end to a second end of the pulley. The disclosure yet includes a tool retainer configured to attach to the pivot and travel in a vertical position parallel with a structure receiving the extension ladder and to the fixed angle of the pivot.

The disclosed hollow rung step ladder pulley hoist and tool retainer system includes a tubular insert having a first end configured to be received into an opening defined by a hollow rung in a side of an extension ladder and a second end configured with at least one pulley sheave wheel, a length of the tubular insert being less than or greater than a width of the rungs of the ladder. The system also includes a pulley cord of a length configured to run once around the at least one pulley sheave wheel and bear a load between a tension portion and a load portion. The system additionally includes a tool retainer configured to attach to the first end of the at least one tubular insert either proximal a received side of the ladder or proximal an opposite side of the ladder for a tubular insert length greater than a width of the rungs of the ladder. The system yet includes a holder configured to be received between the opening defined by a hollow rung in a side of an extension ladder and the tubular insert, the holder adapted to receive a tubular insert from both a left side and a right side of the ladder.

A method of hoisting something via the disclosure includes inserting a rod having a first end configured to be received into an opening defined by a hollow rung in a side of an extension ladder and a second end configured with at least one pulley sheave wheel, a length of the rod being less than or greater than a width of the rungs of the ladder. The method also includes running a pulley cord of a length configured to run once around the at least one pulley sheave wheel and bear a load between a pull portion and a load portion. The method further includes attaching a tool retainer to the first end of the rod either proximal a received side of the ladder or proximal an opposite side of the ladder for a rod length greater than a width of the rungs of the ladder

Other aspects and advantages of embodiments of the disclosure will become apparent from the following detailed description, taken in conjunction with the accompanying drawings, illustrated by way of example of the principles of the disclosure.

### BRIEF DESCRIPTION OF DRAWINGS

FIG. 1 depicts a perspective view of the ladder attached pulley hoist and tool retaining system according to an embodiment of the present disclosure.

FIG. 2 depicts a side perspective view of a conventional extension ladder showing the openings defined by hollow rungs in a side of the ladder.

FIG. 3 depicts a side perspective view of a holder of the hollow rung inserts in accordance with an embodiment of the present disclosure. FIG. 4 depicts a side perspective view of a tool retainer chest or bucket in accordance with an embodiment of the present disclosure.

FIG. 5 depicts a side perspective view of a tool retainer rack in accordance with an embodiment of the present disclosure.

FIG. 6 depicts the drop-in stake stub detail in a drop-in position in accordance with an embodiment of the present disclosure.

FIG. 7 depicts a flow chart of a method for hoisting something via the ladder attached pulley hoist and tool retainer system in accordance with an embodiment of the present disclosure.

FIG. 8 depicts the ladder elevator as inserted in hollow ladder rungs implementing a pulley system of a tool bucket at a vertical angle with a structure in accordance with an embodiment of the disclosure.

FIG. 9 depicts the pivot and nipple structure configured to hold the tool bucket in a fixed angular relation to the rope and a structure in accordance with an embodiment of the present disclosure.

FIG. 10 depicts the pivot and nipple structure from a plane perpendicular to the pivot which is in a fixed relation to the nipple in accordance with an embodiment of the present disclosure.

FIG. 11 is a depiction of the teethed pivot and housing relative to the tool bucket or tool sack in accordance with an embodiment of the present disclosure.

FIG. 12 is a depiction of the teethed pivot and housing relative to the tool bucket or tool sack in accordance with an embodiment of the present disclosure. FIG. 13 is a top view of the nipple and surrounding structures in accordance with an embodiment of the present disclosure.

FIG. 14 is a cutaway depiction of the pivot in relation to ends of the rope in accordance to an embodiment of the present disclosure.

FIG. 15 is a retractable pulley implementation of the ladder attached pulley hoist and tool retainer system in accordance with an embodiment of the disclosure.

Throughout the description, same and similar reference numbers may be used to identify same and similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, the term ‘tubular insert,’ refers to a rod, bar, shaft, stick pole, strut, dowel, spoke, spike and cylindrical extension. The term ‘extension ladder,’ refers to a ladder having sides defining openings for hollow rungs and therefore may include ladders not limited to sliding extensions but also to fixed triangular ladders and non-conventional transforming ladders adapted with side openings for hollow rungs.

The disclosed ladder elevator is a pulley system. It attaches to a universal holder that goes in between the holes that are pre-made from factory on every extended ladder. This is done because all the steps of the ladder are hollow. I created what I call a holder that has a receiver where the pulley system attaches. There are two holders and two pulleys, one goes in the extended top part of the ladder and one goes on the base or bottom part of the ladder on the same side. Creating a rail or elevator this tool contains a hag where items can be stored. As you pull the rope the part can go up and down and will lock in position with a brake or ratchet on the pulleys. The elevator will extend as the ladder extends. Since the holder goes across the steps of the ladder, we can use various attachments for different purposes. For example, a rack for tools such as a hammer or drill, a small bucket or tray for nails and/or smaller hardware. The holder will have universal dips for the different attachments and can be used on either side (right or left). The elevator and attachments work in unison to make work in any field that involves extended ladders, safer and more efficient.

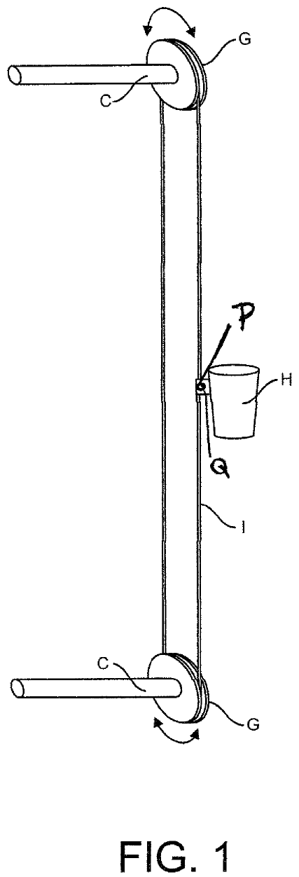

FIG. 1 depicts a perspective view of the ladder attached pulley hoist and tool retaining system according to an embodiment of the present disclosure. The depiction includes the tubular insert C, the pulley wheel G, the movable basket or bucket or bag or container H, the pulley cord or rope I and the basket or bucket pivot P. The loop of pulley cord I is attached at each end to the nipple Q as detailed below according to an embodiment but other configurations including multiple sheave wheels and multiple loops of cord for multiple mechanical advantage are also included and claimed herein. A retractable pulley system is also included in embodiments of the disclosure to fit ladder of varying adjustable lengths.

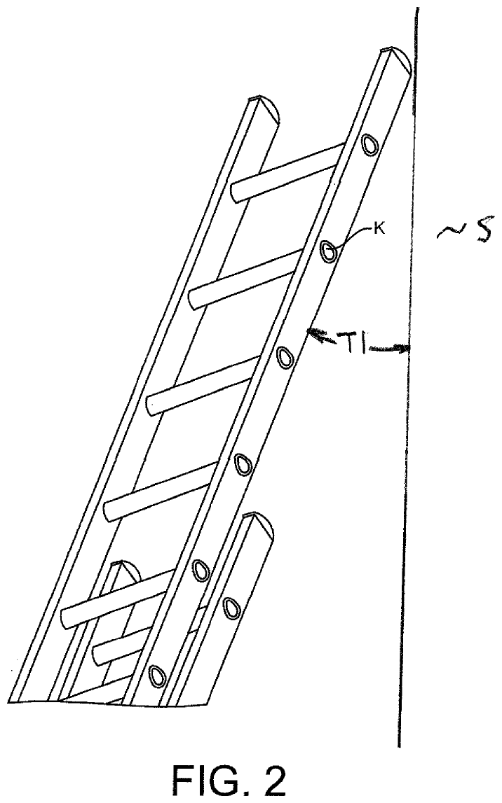

FIG. 2 depicts a side perspective view of a conventional extension ladder showing the openings defined by hollow rungs in a side of the ladder. The hollow rung opening K of the conventional extension ladder is defined in both sides of the ladder. The angle T1 is formed between the ladder leaning up against a structure S such as a house, an office building and construction. Other ladders and other opening geometries are disclosed and claimed herein.

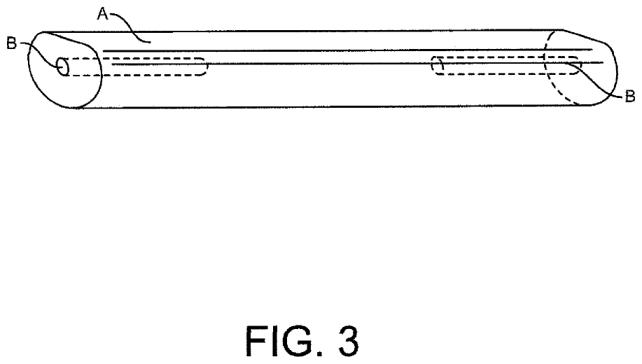

FIG. 3 depicts a side perspective view of a holder of the hollow rung inserts in accordance with an embodiment of the present disclosure. The depiction includes the holder insert A and a hole in the holder insert B. The holder insert A is configured in a shape to fill the hollow rung K (not shown) opening defined in the ladder side. The holder insert A may remain therein or be transient therein. The hole B is designed to receive the tubular insert C (not shown) in a tight frictional relation.

FIG. 4 depicts a side perspective view of a tool retainer chest or bucket in accordance with an embodiment of the present disclosure. The tubular insert C is long enough to extend all the way through a width of the ladder defined by its rungs. Therefore, the tool bucket D may be attached to a left side or to a right side proximal the ladder side according to a preference of the owner operator. The draining hole J shown in broken lines enables moisture to escape the tool bucket D.

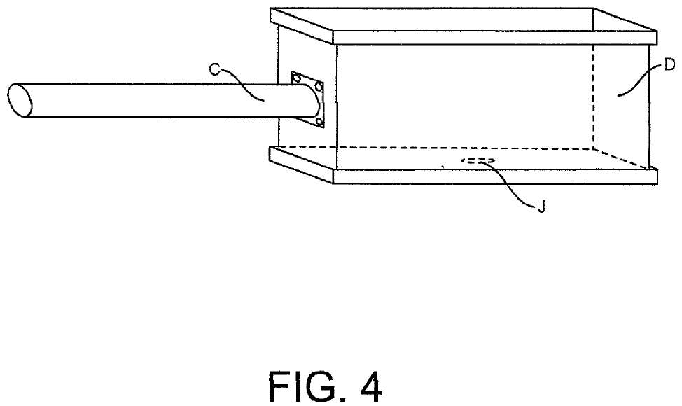

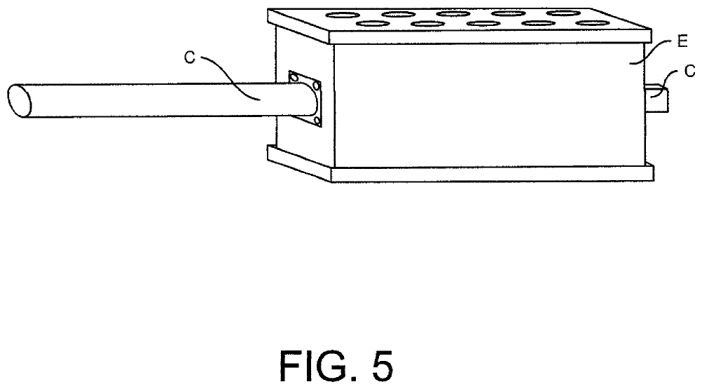

FIG. 5 depicts a side perspective view of a tool retainer rack in accordance with an embodiment of the present disclosure. The tubular insert C is shown detached from the pulley sheave wheel and attached to a tool rack top of a chest E or retainer. The tool rack chest E comprises multiple openings to receive multiple tools such as screw drivers, files, pliers and wrenches of conventional handle length.

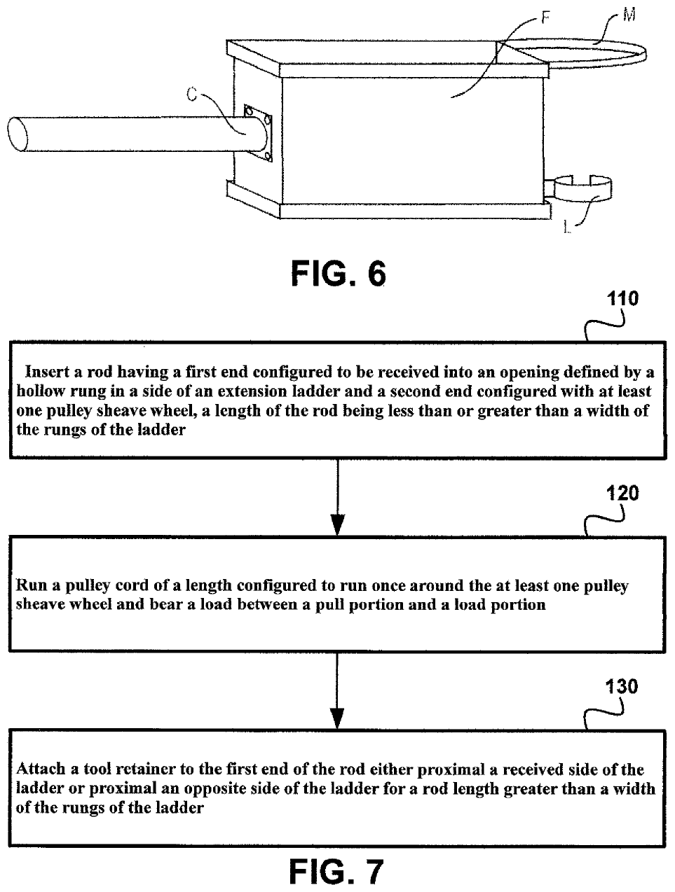

FIG. 6 depicts the drop-in stake stub detail in a drop-in position in accordance with an embodiment of the present disclosure. The tool helper F comprises loops such as M used for retaining longer handle tools such as small shovels, pry bars etc. The tool helper F also comprises clips L for holding tools. The tool helper F body itself holds nails, rivets, screws and miscellaneous fasteners and tools.

FIG. 7 depicts a flow chart of a method for hoisting something via the ladder attached pulley hoist and tool retainer system in accordance with an embodiment of the present disclosure. The method of hoisting something via the disclosure includes inserting 110 a rod having a first end configured to be received into an opening defined by a hollow rung in a side of an extension ladder and a second end configured with at least one pulley sheave wheel, a length of the rod being less than or greater than a width of the rungs of the ladder. The method also includes running 120 a pulley cord of a length configured to run once around the at least one pulley sheave wheel and bear a load between a pull portion and a load portion. The method further includes attaching 130 a tool retainer to the first end of the rod either proximal a received side of the ladder or proximal an opposite side of the ladder for a rod length greater than a width of the rungs of the ladder.

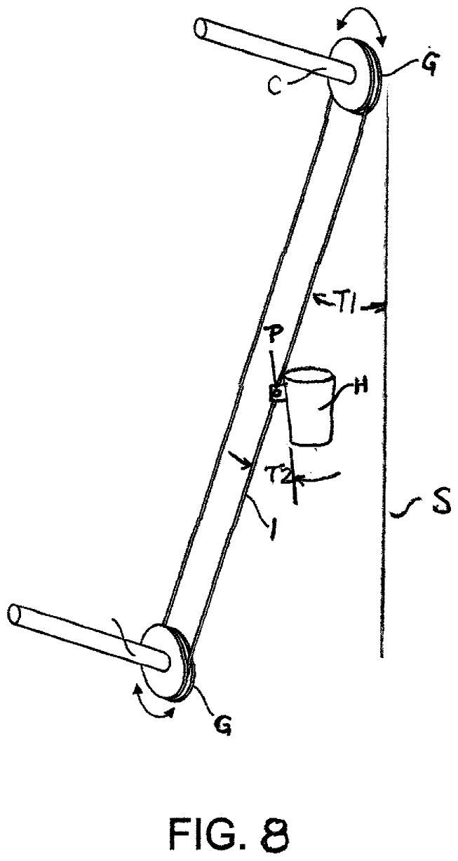

FIG. 8 depicts the ladder elevator as inserted in hollow ladder rungs implementing a pulley system of a tool bucket at a vertical angle with a structure in accordance with an embodiment of the disclosure. The depiction includes the tabular inserts C, the pulley wheels G and rope I, bucket H, pivot P, nipple Q and the angle T1 between the rope I and a vertical placement of the bucket H parallel to a structure such as a house denoted by angle T2 in relation to the house, an office building and construction, etc. T1 and T2 are equal according to details below regarding the pivot P structure and setting.

FIG. 9 depicts the pivot and nipple structure configured to hold the tool bucket in a fixed angular relation to the rope and a structure in accordance with an embodiment of the present disclosure. The pivot P is depicted as a protuberance on the nipple Q at a midsection thereof. The cracks or fissures R in the nipple Q allow a compression fit of the nuts N1 and N2 over respective ends of the rope I1 and 12 so the rope is continuous in the pulley system disclosed. The nut N1 is not yet torqued onto the respective nipple end as shown in FIG. 10 and described below.

FIG. 10 depicts the pivot and nipple structure from a plane perpendicular to the pivot which is in a fixed relation to the nipple in accordance with an embodiment of the present disclosure. The same references as for FIG. 9 are used with the addition of nut N2 and N1 torqued onto the nipple Q.

FIG. 11 is a depiction of the teethed pivot and housing relative to the tool bucket or tool sack in accordance with an embodiment of the present disclosure. The depiction includes a housing U for the nipple Q shown in broken lines in relation to the rope I and the bucket H. The pivot P has teeth to enable a locking in place in relation to the nipple Q, the bucket H and the housing U and a structure S not depicted.

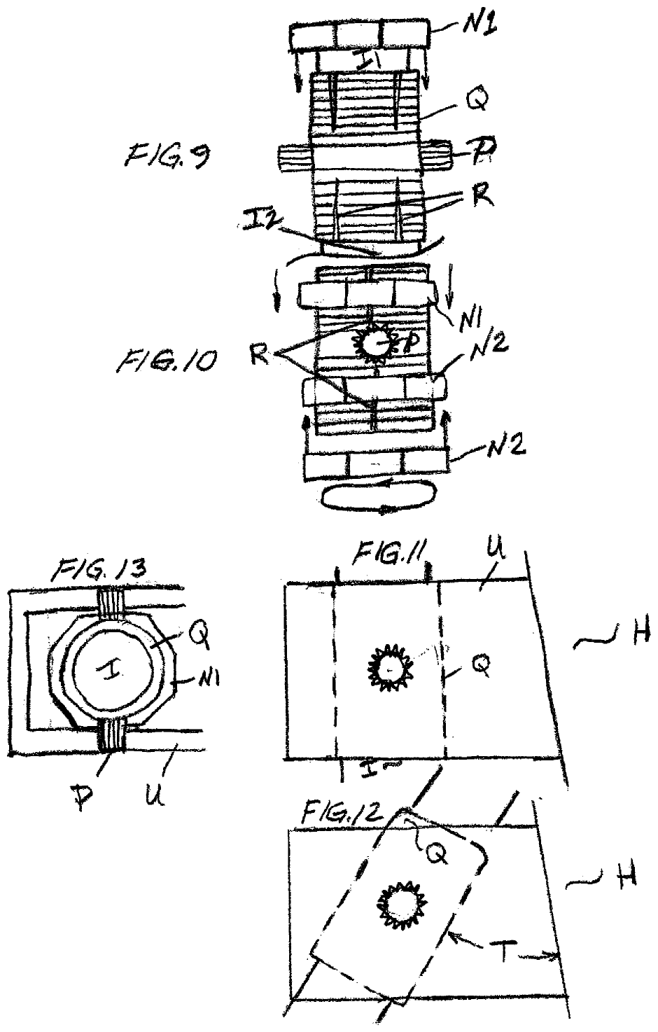

FIG. 12 is a depiction of the teethed pivot and housing relative to the tool bucket or tool sack in accordance with an embodiment of the present disclosure. The depiction includes a housing U for the nipple Q shown in broken lines in relation to the rope I and the bucket H. The pivot P has teeth to enable a locking in place in relation to the nipple Q, the bucket H and the housing U and a structure S not depicted.

FIG. 13 is a top view of the nipple and surrounding structures in accordance with an embodiment of the present disclosure. The nipple Q, the nut N1, the pivot P and the housing U are shown relative to the rope inserted and adjoined thereto.

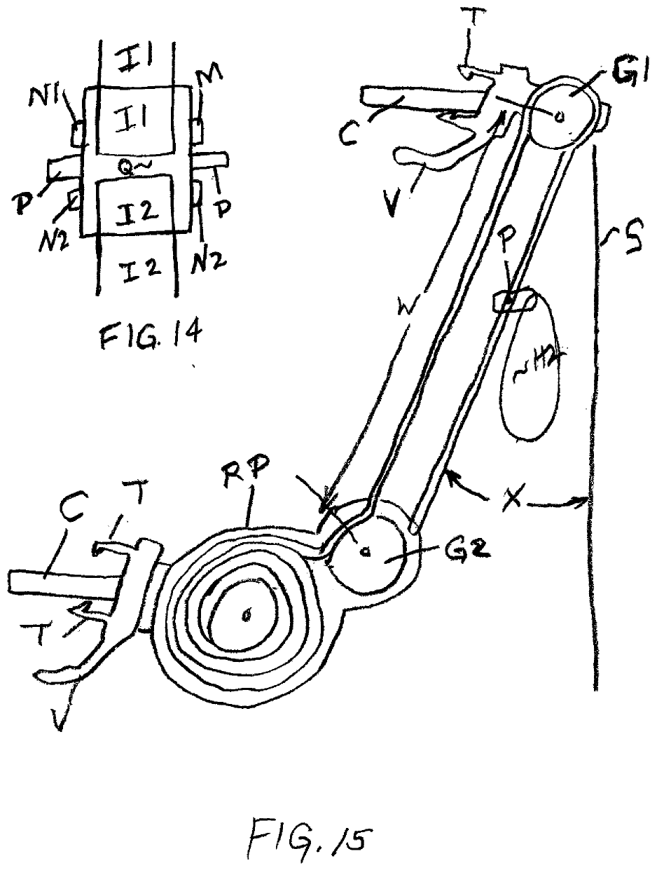

FIG. 14 is a cutaway depiction of the pivot in relation to ends of the rope in accordance to an embodiment of the present disclosure. The depiction includes the pivot P, the nuts N1 and N2, rope ends I1 and 12, relative to the nipple Q in accordance with an embodiment of the present disclosure.

FIG. 15 is a retractable pulley implementation of the ladder attached pulley hoist and tool retainer system in accordance with an embodiment of the disclosure. In addition to shared reference letters with other drawings in the disclosure, the depiction includes a retractable pulley RP with ends G1 and G2 and tubular inserts C, pivot P and tool bag H2. Teeth Z are used to engage with the tubular inserts C to anchor the retractable pulley system to the ladder at hollow rungs K. The tool bag H2 runs the length of the pulley W between the ends G1 and G2 in a fixed angular and adjustable angle relative to the structure S given by the angle X. Teeth T can be used to clamp onto tubular insert C and put the apparatus into the side of a hollow rung ladder or from a wooden step ladder. A stabilizer V keeps the apparatus from up and down movements on the respective ladder.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A hollow rung ladder apparatus:
a first tubular insert and a second tabular insert each having a first end received into a hollow rung of the hollow rung ladder and a second end configured to receive a respective end of a two end pulley;
a pivot configured to attach to a rope of the pulley and to travel on the rope at a fixed point on the rope and at fixed angle to the rope and from a first end to a second end of the pulley; and
a tool retainer configured to attach to the pivot and travel in a vertical position parallel with a structure receiving the extension ladder and to the fixed angle of the pivot.

2. The apparatus of claim 1, wherein the pulley is a retractable pulley.

3. The apparatus of claim 1, wherein the tool retainer is a tool bucket configured to receive miscellaneous tools and hardware including nails and screws.

4. The apparatus of claim 1, wherein a length of the tubular insert is greater than a width of the rungs of the ladder.

5. The apparatus of claim 1, wherein the tool retainer includes loops to receive long tools including hammers, pliers and saws.

6. The apparatus of claim 1, further comprising a tool bag configured to attach to the pulley cord on the load portion of the pulley cord length via the pivot.

7. The apparatus of claim 1, further an electric motor configured to turn a retractable pulley sheave wheel.

8. The apparatus of claim 1, wherein a pulley cord length comprises a closed loop between a first pulley sheave wheel end and a second pulley sheave wheel end.

9. The method of claim 1, further comprising adjusting a length of the retractable pulley to match a height of the hollow rung ladder.
